(19) United States
(12) Patent Application Publication
(10) Pub. No.: US 2023/0220599 A1
(43) Pub. Date: Jul. 13, 2023

(54) FABRIC, MULTI-LAYER FABRIC, TRANSITION ELEMENT, AND VEHICLE, BOARDING BRIDGE, BOARDING STAIRS OR BUILDING CONNECTION

(71) Applicant: HÜBNER GmbH & Co. KG, Kassel (DE)

(72) Inventors: Christian Hirling, Bad Karlshafen (DE); Reinhard Hübner, Kassel (DE); Andreas Wiegrefe, Fulda (DE)

(21) Appl. No.: 18/151,209

(22) Filed: Jan. 6, 2023

(30) Foreign Application Priority Data
Jan. 12, 2022 (EP) 22151141.3

(51) Int. Cl. D06C 3/00

(52) U.S. Cl. CPC D06C 3/00; D10B 2401/061; D10B 2401/062

(57) ABSTRACT

A fabric is for a transition element for the protection of a transition area between two interconnected components or vehicle parts that can move relative to each other. The fabric has at least one first section, and at least one second section. The first section and the second section differ with respect to at least one mechanical property. The first section has at least one material weakening to change the at least one mechanical property in the first section.

### CROSS-REFERENCE TO RELATED APPLICATIONS

This application claims priority to European patent application 22151141.3, filed Jan. 12, 2022, which is hereby incorporated by reference in its entirety.

### FIELD OF THE INVENTION

The invention concerns a fabric and a multi-layer fabric. Furthermore, the invention concerns the production of a fabric and a multi-layer fabric. Likewise, the invention concerns a transition element with a fabric or a multi-layer fabric. Another aspect of the invention concerns a vehicle, a boarding bridge, boarding stairs, or a building connection with a transition element that comprises a fabric or a multi-layer fabric.

### BACKGROUND OF THE INVENTION

Movably connected components, e.g. in a vehicle, at a boarding bridge, at boarding stairs or in buildings, can have a transition area between them. The transition area can be protected by a transition area protection (also called transition element). Such transition area protection can be designed as a corrugated or a folding bellows. The shape of the corrugated or folding bellows can adapt to the positions of the movably connected components.

Such transition area protection must fulfill various functions. The transition area protection must be able to withstand mechanical stress, be sufficiently deformable, and be durable.

To fulfill the various functions, corrugated or folding bellows are often made of different elements, the different elements being shaped differently and being joined together to produce a bellows or a bellows section. Frequently, corrugated or folding bellows are custom-built or made to measure. This makes their production elaborate and costly.

WO 2018/146227 A1 discloses a fabric having areas that have different mechanical properties. One area is reinforced, and another area is not reinforced.

### SUMMARY OF THE INVENTION

The invention is based on the task of providing a fabric that can be manufactured simply and cost-efficiently. A further task of the invention is to provide a fabric the mechanical properties of which can be tailored to a specific application in a simple and cost-efficient way.

The task is solved by the disclosed embodiments. Further embodiments of the invention are also disclosed.

Shown is a fabric for a transition element for the protection of a transition area between two interconnected components or vehicle parts that can move relative to each other. The fabric has at least one first section, and at least one second section. The first section and the second section differ with respect to at least one mechanical property. The first section has at least one material weakening to change the at least one mechanical property in the first section.

The fabric can be made of one piece. The fabric can be composed of identical (sheet-like) elements. The (entire) fabric can consist of one material, e.g. a cloth or a composition. In other words, the fabric can have identical sections of identical materials.

The fabric can also be composed of sections of different materials which already, e.g. intrinsically, i.e., without incorporation of the material weakening, differ with respect to at least one mechanical property. By incorporating a material weakening in at least one of the sections, the mechanical properties of that section can be further changed purposefully compared to the at least one other section.

The fabric can be a textile fabric. A textile fabric can comprise one or multiple textiles or be made of one or multiple textiles. The fabric can be a sheet-like backing textile, preferably a sheet-like backing fabric.

Instead of a textile fabric, the fabric may also be a different type of fabric. For example, the fabric can be a foil based on plastic or elastomer. Only to mention a further example, the fabric can also be plates of fiber-reinforced composite material, such as glass-fiber reinforced plastic plates, and flexible plates of the most varied designs, materials and surfaces.

A mechanical property of the section can be changed due to the at least one material weakening (also called weakening, for short) in a section. The change can relate to the mechanical property of the section without the material weakening or prior to incorporation of the material weakening.

For example, a fabric made of one material with one mechanical property can be provided. If different sections of the fabric are to have different values of the mechanical property, a material weakening can be provided in at least one section of the fabric. Due to the material weakening, the value of the mechanical property can be changed, e.g. reduced, in the area that has the material weakening. This allows easy adaptation of the fabric provided for a desired application if different measures or values of a mechanical property are desired for the application in different sections.

The at least one property can comprise or be a bending stiffness. The bending stiffness can be determined in accordance with VDA 230-209 Part C, in particular in the version valid on the day of filing. In the first section of the fabric, the bending stiffness can be lower than in the second section of the fabric. Due to the at least one material weakening in the first section, the bending stiffness can be reduced compared to the bending stiffness in the section without material weakening.

The bending stiffness of a second section (without material weakening) of the fabric can be a maximum of 100 Nmm. Preferably, the maximal bending stiffness is 75 Nmm. The bending stiffness in warp direction can be between 1 Nmm and 75 Nmm. The bending stiffness in weft direction can be between 0.5 Nmm and 40 Nmm.

The at least one property can comprise or be an elasticity. The elasticity can be determined in accordance with DIN EN ISO 20932-1:2020-05. In the first section of the fabric, the elasticity can be higher or lower than in the second section of the fabric. Due to the at least one material weakening in the first section, the elasticity can be increased or reduced compared to the elasticity in the first section without material weakening.

The at least one property can comprise or be a modulus of elasticity. The modulus of elasticity can be determined using known methods. In the first section of the fabric, the modulus of elasticity can be lower than in the second section of the fabric. Due to the at least one material weakening in the first section, the modulus of elasticity can be reduced compared to the modulus of elasticity in the first section without material weakening.

The at least one property can comprise or be a maximum tensile force. The maximum tensile force can be determined in accordance with DIN EN ISO 13934-1:2013-08. In the first section of the fabric, the maximum tensile force can be lower than in the second section of the fabric. Due to the at least one material weakening in the first section, the maximum tensile force can be reduced compared to the maximum tensile force in the first section without material weakening.

The at least one property can comprise or be an elongation at maximum force. The elongation at maximum force can be determined in accordance with DIN EN ISO 13934-1:2013-08. In the first section of the fabric, the elongation at maximum force can be greater than in the second section of the fabric. Due to the at least one material weakening in the first section, the elongation at maximum force can be increased compared to the elongation at maximum force in the first section without material weakening.

The at least one property can comprise or be a tensile force. The tensile force can be determined in accordance with DIN EN ISO 13934-1:2013-08. In the first section of the fabric, the tensile force can be lower than in the second section of the fabric. Due to the at least one material weakening in the first section, the tensile force can be reduced compared to the tensile force in the first section without material weakening.

The at least one property can comprise or be an elongation. The elongation can be determined in accordance with DIN EN ISO 13934-1:2013-08. In the first section of the fabric, the elongation can be greater than in the second section of the fabric. Due to the at least one material weakening in the first section, the elongation can be increased compared to the elongation in the first section without material weakening.

The first section and the second section can differ with respect to at least two of the properties mentioned, preferably at least three of the properties mentioned.

In general, higher or greater can mean at least 1%, preferably at least 5%, more preferably at least 10%, more preferably at least 20% higher or greater. Lower can mean at least 1%, preferably at least 5%, more preferably at least 10%, more preferably at least 20% lower.

The material weakening can be a recess, a perforation, an indentation, a contraction, and/or a reduction of thickness. The material weakening can be effected by using yarns of different thickness or different diameters. The fabric can comprise a yarn of lower thickness or lower diameter in the first section, at least in sections, than in the second section. The material weakening can be effected by the yarn of lower thickness or lower diameter. Preferably, the material weakening is incorporated into one section of the fabric. In particular, the material weakening is a perforation, preferably a laser perforation.

The material weakening can extend completely or not more than partly through the fabric, in particular from a first side of the fabric to a second side of the fabric.

The material weakening can have a circular, oval, triangular, quadrangular, in particular rectangular or quadratic, or n-gonal cross-section. The cross-section of the material weakening can be located in a plane defined by the fabric. The material weakening can also have any other geometry.

The material weakening can have a cross-sectional area of at least 0.5 mm², preferably at least 1 mm², more preferably at least 3 mm², more preferably at least 6 mm². The material weakening can have a cross-sectional area of not more than 100 mm², preferably not more than 50 mm², more preferably not more than 20 mm².

The first section of the fabric can have a multitude of material weakenings. Preferably, the first section of the fabric has at least 10 material weakenings, preferably at least 50 material weakenings, more preferably at least 100 material weakenings. The first section of the fabric can be a cohesive section. Each of the material weakenings can be any of the material weakenings disclosed herein.

The first section of the fabric can have between 0.01 material weakenings per cm² and 100 material weakenings per cm². Preferably, the first section of the fabric has between 0.05 material weakenings per cm² and 50 material weakenings per pro cm², more preferably between 0.1 material weakenings per cm² and 10 material weakenings per cm².

The material weakenings can be arranged in a regular grid pattern in the first section. For example, the material weakenings can be arranged along imaginary lines that cross each other, the material weakenings, preferably the central points of the material weakenings, being arranged at the points of intersection of the lines. First lines can be arranged at regular distances to and in parallel with one another, and second lines can be arranged at regular distances to and in parallel with one another. An angle between first and second lines preferably is not 0° and not 180°. In particular, the angle between first and second lines is 90°. As an alternative, the material weakenings can be arranged unevenly in the first section of the fabric.

An area of the first section can be at least 5%, preferably at least 10%, of a total area of the fabric. The area of the first section can be no more than 50%, preferably not more than 30%, of the total area of the fabric. An area of the second section can be at least 20%, preferably at least 50%, of a total area of the fabric. The area of the second section can be no more than 90%, preferably not more than 70%, of the total area of the fabric.

An area of the first section can be at least 10 cm², preferably at least 20 cm², more preferably at least 30 cm².

The fabric can have at least two first sections. Preferably, the fabric has at least three, more preferably at least four, first sections. The first sections can be arranged at a distance to one another in the fabric. The different first sections can have identical or different material weakenings. For example, the geometries and/or the number of perforations per unit area may be different.

The fabric can comprise or be made of a polyester, a polyamide, an aramid, polypropylene, cotton and/or viscose. However, other materials can also be used. The fabric can be a woven fabric, a crocheted fabric, a knitted fabric, a non-woven fabric, or a scrim (e.g. a laid scrim).

Shown is a multi-layer fabric for a transition element for the protection of a transition area between two interconnected components or vehicle parts that can move relative to each other. The multi-layer fabric comprises a fabric disclosed herein. At least one side of the fabric has a coating.

All sides of the fabric may have the coating. The fabric may be completely enclosed or covered by the coating.

The coating can comprise a plastic. In particular, the coating comprises an elastomer, a silicone, a chlorosulfonated polyethylene, a TPU (thermoplastic polyurethane), EPDM (ethylene-propylene-diene caoutchouc) and/or PVC (polyvinyl chloride).

The thickness of the coating can exceed the thickness of the fabric. Alternatively, the coating can be less thick than the fabric. The direction of the thickness can be perpendicular to the areal extension of the fabric.

Mechanical properties of the multi-layer fabric can be provided and influenced by the fabric. The coating can likewise influence the mechanical properties of the multi-layer fabric. Furthermore, the coating can protect the fabric against environmental influences, confer a sound-insulting property to the multi-layer fabric and/or improve the durability of the multilayer fabric.

Shown is a method for the production of a fabric for a transition element for the protection of a transition area between two interconnected components or vehicle parts that can move relative to each other. The method comprises the following steps: Provision of a surface element having at least one mechanical property and at least one first section and at least one second section; application or incorporation of at least one material weakening onto or into the surface element in the first section, so that the at least one mechanical property in the first section is changed; and obtaining of a fabric having at least the first section and at least the second section, the first section and the second section being different with respect to the at least one mechanical property.

Any of the fabrics disclosed herein can be produced with the method.

The application or incorporation of the material weakening onto or into the surface element in the first section can be effected by means of a perforation, in particular a laser perforation.

The method can comprise the following in addition: Separation of a shape section of the surface element. The shape section can comprise the first section and the second section. The shape section can have a shape. The fabric can have the shape of the shape section.

The method can comprise the following in addition: Application of a coating onto at least one side of the surface element or the fabric. The coating can cover the first section at least partly, in particular completely. The coating can be applied to the surface element or the fabric in such a way that the coating completely covers or encloses the surface element or the fabric.

For the production of a transition element for the protection of a transition area between two interconnected components or vehicle parts that can move relative to each other, the method can comprise the following in addition: Separation of a part from the fabric or the multi-layer fabric and/or shaping of a/the part of the fabric or the multi-layer fabric in accordance with a predefined contour. For example, a shaped part for a corrugation or a fold of a gangway bellows can be separated and/or shaped. In the process, the separation and/or shaping can be done in such a way that the first section and the second section each are oriented in such a way that the mechanical properties are suitable for the desired contour.

The second section of the fabric can have the at least one mechanical property of the surface element.

The at least one mechanical property of the surface element can be unchanged, in particular in the second section. In other words, the at least one mechanical property of the surface element can remain unchanged, in particular in the second section. In particular, the mechanical property can remain unchanged during the production of the fabric.

Shown is a transition element for the protection of a transition area between two interconnected components or vehicle parts that can move relative to each other. The transition element can comprise any of the fabrics disclosed herein. The transition element can comprise any of the multi-layer fabrics disclosed herein.

The transition element can have a cross-section with corner areas. The corner areas can be rounded. Preferably, a first section of the fabric is provided in at least one of the corner areas. Especially preferably, a first section of the fabric is provided in each of the corner areas. To this end, the fabric can have at least four first sections. The cross-section of the transition element can be quadrangular, in particular rectangular or quadratic. The transition element can have four corner areas.

The transition element can be a gangway bellows. Preferably, the transition element is a corrugated or a folded bellows.

In particular in the case of a corrugated or a folded bellows, multiple sections, which differ as regards type and degree of the material weakening, can be provided in the corner areas of the fabric used for the bellows. The material weakening in the edge areas of the corrugations can be more intense than in the center area. Specifically, perforations in the edge area can have a larger cross-section than towards the center. The cross-section of the perforations can, e.g., decrease gradually towards the center.

Shown is a vehicle, a boarding bridge, or a building connection having two interconnected components or vehicle parts that can move relative to each other. The vehicle, the boarding bridge, or the building connection can comprise any of the transition elements disclosed herein.

### BRIEF DESCRIPTION OF THE DRAWINGS

In the following, the disclosure, or further embodiments and advantages of the disclosure, are explained in more detail with the help of figures, the figures only describing embodiments of the disclosure. Identical components in the figures have identical reference signs.

a.

FIG. 1 shows a top view of a fabric 100 with indicated A-A sectional view;

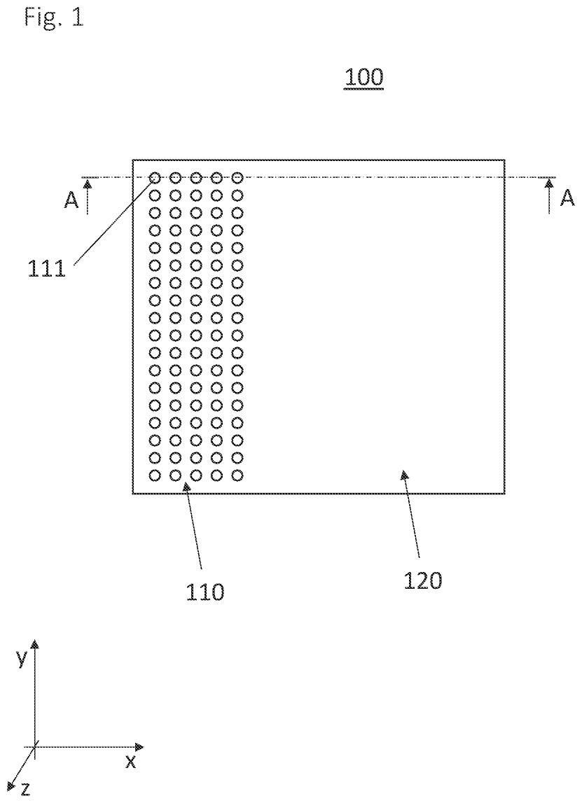

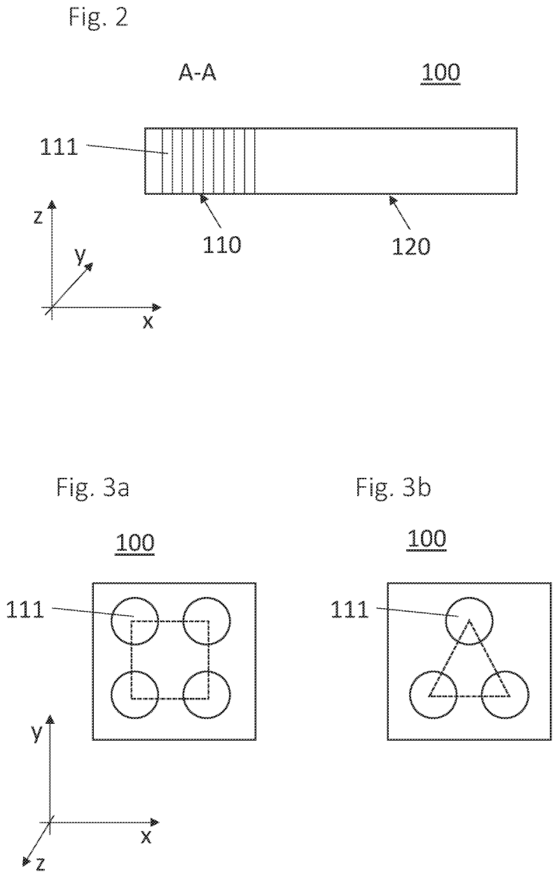

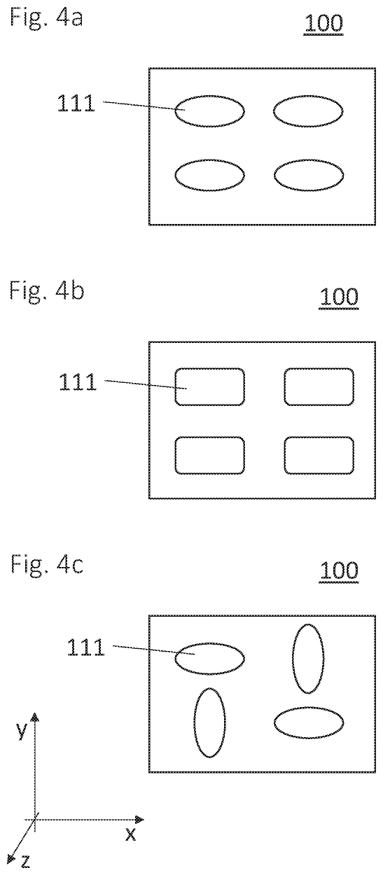

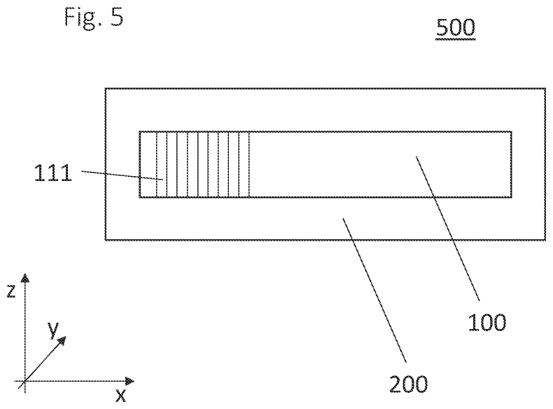

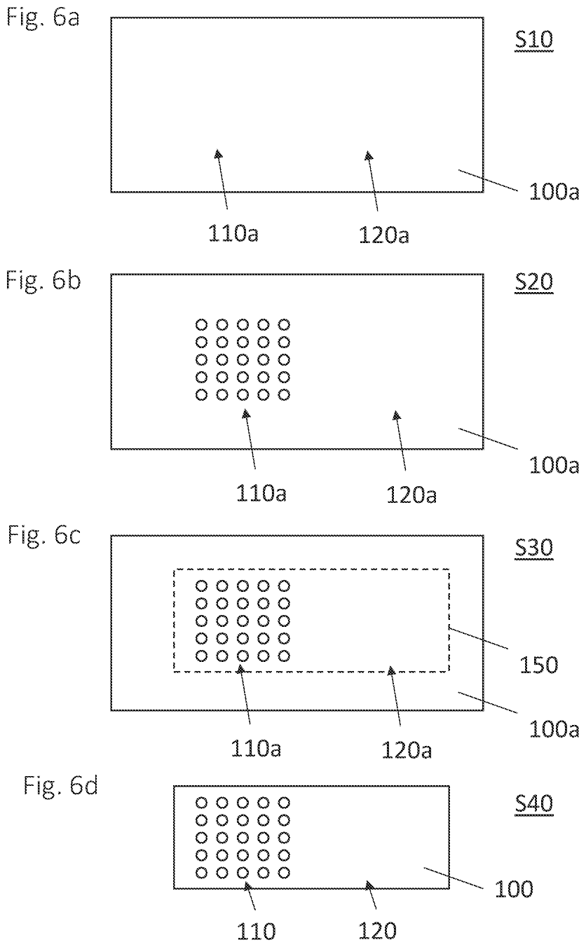

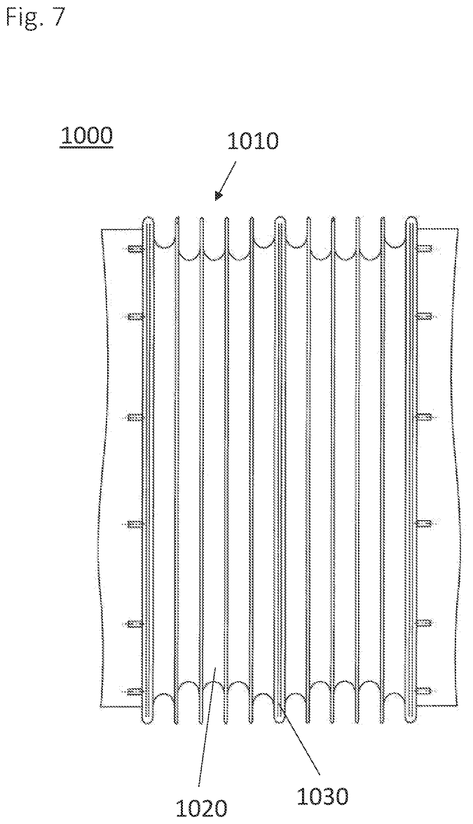

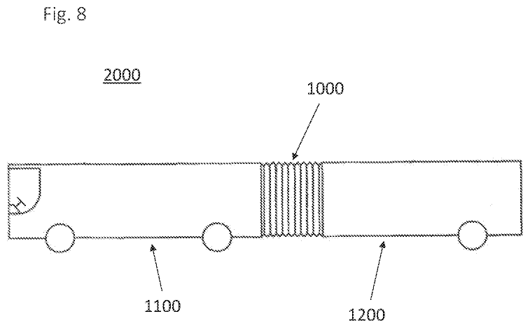

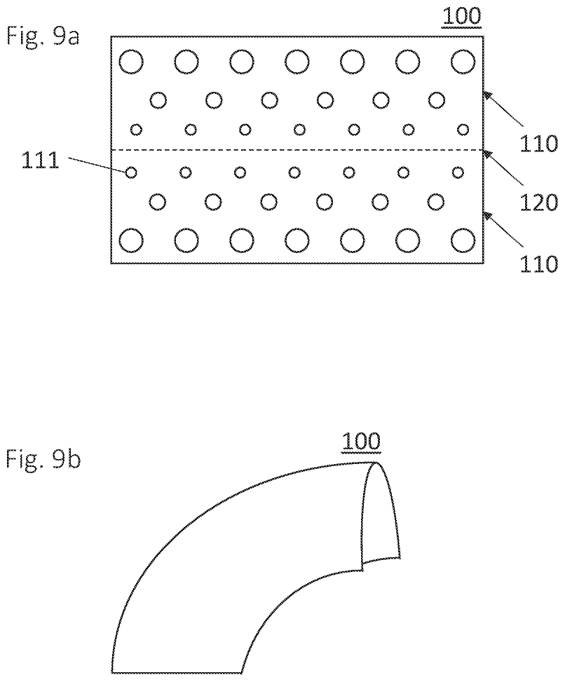

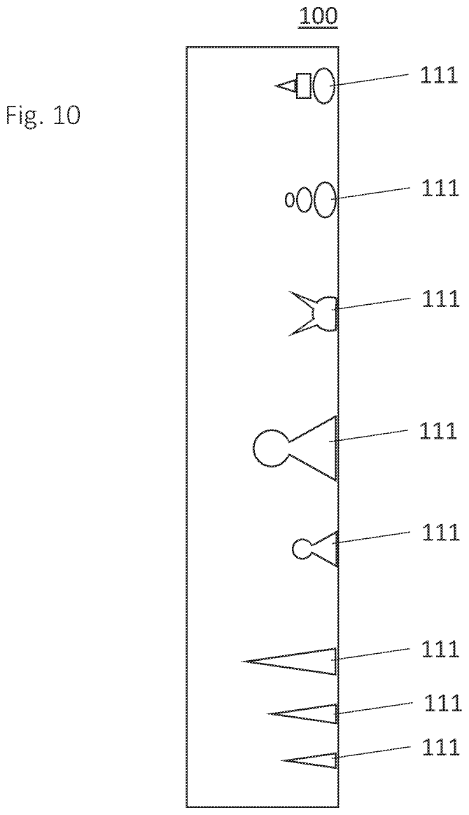

b. FIG. 2 shows the fabric 100 in the A-A sectional view indicated in FIG. 1;

c. FIG. 3a shows a schematic diagram of an arrangement of material weakenings 111 in a fabric 100;

d. FIG. 3b shows a schematic diagram of an arrangement of material weakenings 111 in a fabric 100;

e. FIG. 4a shows a schematic diagram of a design of material weakenings 111 in a fabric 100;

f. FIG. 4b shows a schematic diagram of a design of material weakenings 111 in a fabric 100;

g. FIG. 4c shows a schematic diagram of a design of material weakenings 111 in a fabric 100;

h. FIG. 5 shows, schematically, a sectional view of a multi-layer fabric 500;

i. FIG. 6a shows a step in the production of a fabric 100;

j. FIG. 6b shows a further step in the production of a fabric 100;

k. FIG. 6c shows a further step in the production of a fabric 100;

l. FIG. 6d shows a further step in the production of a fabric 100;

m. FIG. 7 shows a transition element 1000;

n. FIG. 8 shows a vehicle 2000;

o. FIG. 9a shows a schematic diagram of a fabric 100 for a corner;

p. FIG. 9b shows the fabric 100 shaped into the corner according to FIG. 9a; and

q. FIG. 10 shows a schematic diagram of several designs of material weakenings 111 in a fabric 100.

### DETAILED DESCRIPTION OF THE INVENTION

FIG. 1 shows, schematically, a top view of a fabric 100. The fabric 100 can define an X-Y-plane. The plane can be defined by the areal extension of the fabric 100. A Z-direction can be oriented perpendicular to the X-Y-plane. The thickness of the fabric 100 can be oriented in the Z-direction.

The fabric 100 can have a width (e.g. in X-direction) and/or a length (e.g. in Y-direction) that is a multiple of its thickness (e.g. in Z-direction). The multiple can be at least five, preferably at least ten, more preferably at least twenty.

The fabric 100 can have a thickness that essentially (±10% or ±5%) is constant, in particular across the entire extension of the fabric 100.

The fabric 100 has a first section 110 and a second section 120. The fabric 100 can have multiple first sections 110, in particular at least two, at least three, or at least four first sections 110. Especially preferably, the fabric 100 has exactly four first sections 110. Each of the first sections 110 can be any of the first sections 110 disclosed herein.

Alternatively, or in addition, the fabric 100 can have multiple second sections 120, e.g. at least two, at least three, or at least four second sections 120. Preferably, the fabric 100 has exactly four second sections 120. Each of the second sections 120 can be any of the second sections 120 disclosed herein.

First sections 110 and second sections 120 can be provided in the fabric 100 alternatingly. A second section 120 can follow a first section 110, a further section 110 can follow the second section 120. The alternating arrangements of first and second sections 110, 120 can be viewed in a direction of the X-Y-plane, for example in X-direction and/or in Y-direction.

A distance between a first section 110 and a second section 120 can be at least 0.5 m, preferably at least 1.0 m, more preferably at least 1.5 m, more preferably at least 2.0 m.

The first section 110 has at least one material weakening 111. Preferably, the first section 110 has a multitude, in particular at least 10, at least 50, or at least 100, material weakenings. Each of the material weakenings 111 can be any of the material weakenings 111 disclosed herein. The material weakenings 111 of different first sections 110 of a fabric 100 can be of different or of identical type and arrangement.

The second section 120 preferably has no material weakening 111. A second section 120 can be a section of the fabric 100 with an area of at least 10 cm², at least 50 cm², at least 100 cm², or at least 200 cm² which has no material weakening 111.

In the first section 110, a distance between neighboring material weakenings 111 can be at least 1 mm, preferably at least 3 mm, more preferably at least 10 mm. The distance can be located in the X-Y-plane.

The first section 110 and the second section 120 differ with respect to at least one mechanical property. Preferably, the first section 110 and the second section 120 differ with respect to at least two, preferably at least three mechanical properties. The bending stiffness, the elasticity, the modulus of elasticity, the maximum tensile force, the maximum force at elongation, the tensile force and the elongation, as herein described, can each be a mechanical property. In general, a value of the mechanical property can be different in case of a difference in a mechanical property. For example, the value of a mechanical property in the first section 110 can be higher or lower than the value of the (same) mechanical property in the second section 120.

The mechanical property of the second section 120 can be equal to the mechanical property of the fabric 100 without material weakening 111, in particular for the same test specimen. The mechanical property can be changed due to the material weakening 111, so that the mechanical property in the first section 110, which comprises at least one material weakening 111, is changed.

In general, the material weakening 111 can be a structural or a physical change in the fabric 100. The material weakening 111 can be incorporated subsequently into a surface element (e.g. a fabric precursor). In other words, a surface element or a fabric precursor can be processed by incorporating or applying a material weakening 111, so that a mechanical property changes. This is described in more detail below with a view to FIGS. 6a to 6d.

The material weakening 111 can be a recess, a perforation, an indentation, a contraction, and/or a reduction of thickness. Especially preferably, the material weakening 111 is a perforation, in particular a laser perforation.

The fabric 100 can be flexible or non-rigid.

The A-A sectional view indicated in FIG. 1 is shown schematically in FIG. 2. Multiple material weakenings 111 are shown in the first section 110.

In the example of FIG. 2, the material weakening 111, or each of the material weakenings 111, extend(s) completely through the fabric 100. The material weakening 111 can extend from a first side of the fabric 100 to a second side of the fabric 100. The second side of the fabric 100 can be located opposite the first side of the fabric 100. Such a material weakening 111 can be produced by punching or laser perforation.

Likewise, the material weakening 111 can extend incompletely through the fabric 100. The material weakening 111 can extend not more than partly through the fabric 100. For example, the thickness of the fabric 100 can be reduced to produce a material weakening 111. This can be done by removing material of the fabric 100. Likewise, a section of the fabric 100 can be contracted or be squeezed.

The material weakening 111 can be incorporated into the fabric 100 without reduction of the thickness or without (mechanical) removal of material of the fabric 100. In case of a material weakening 111, the fabric 100 can have the same thickness as outside of the material weakening 111. To this end, the fabric 100 can, e.g., be exposed to electromagnetic radiation to alter the structure of the fabric 100. The thickness of the fabric 100 can remain unchanged in the process.

The material weakening 111 can extend perpendicular to the X-Y-plane, that is, e.g. in Z-direction. The material weakening 111 can extend at an angle (not 90°) to the X-Y-plane. An angle between the material weakening 111 and the X-Y-plane can be between 10° and 80°, preferably between 30° and 60°.

FIGS. 3a and 3b each show a schematic diagram of an arrangement of material weakenings 111 in a fabric 100.

In FIG. 3a, the central points of the material weakenings 111 are arranged at corners of an imaginary quadrangle. The imaginary quadrangle is indicated by a broken line. The imaginary quadrangle and the central points of the material weakenings 111 can be located in the X-Y-plane. The quadrangle can be a rectangle, a square, a trapezoid, a rhombus, a kite, or a concave rectangle. The central points of four of the material weakenings 111 in each case, in particular of four of all material weakenings 111 in each case, in the first section 110 can be located at corners of the imaginary quadrangle. The imaginary quadrangle can be identical for all material weakenings 111. One central point each of a material weakening 111 can be arranged at a corner of the imaginary quadrangle.

In FIG. 3b, the central points of the material weakenings 111 are arranged at corners of an imaginary triangle. The imaginary triangle is indicated by a broken line. The imaginary triangle and the central points of the material weakenings 111 can be located in the X-Y-plane. The triangle can be an equilateral triangle, an isosceles triangle, a right-angled triangle, or an irregular triangle. The central points of three of the material weakenings 111 in each case, in particular of three of all material weakenings 111 in each case, in the first section 110 can be located at corners of the imaginary triangle. The imaginary triangle can be identical for all material weakenings 111. One central point each of a material weakening 111 can be arranged at a corner of the imaginary triangle.

The material weakenings 111 can be arranged in a regular grid pattern in the first section 110. Alternatively, the material weakenings 111 can be arranged not in a regular grid pattern in the first section 110. The material weakenings 111 can be randomly distributed in the first section 110. The material weakenings 111 can be quasi-randomly distributed in the first section 110. A random distribution can be determined by means of a randomized algorithm. A quasi-random distribution can be determined by means of a non-randomized algorithm.

FIGS. 4a to 4c show material weakenings 111 with different forms in a fabric 100.

FIG. 4a shows material weakenings 111 in the fabric 100. The material weakenings 111 have a noncircular, in particular oval, cross-section. The cross-section can be located in the X-Y-plane. Due to a noncircular cross-section, the mechanical property can be anisotropic, that is directional. In a first direction (e.g. in X-direction), the mechanical property can be different from the mechanical property in a second direction (e.g. in Y-direction). Preferably, the first direction is nonparallel to the second direction, especially preferably the first direction is perpendicular to the second direction. The first and the second direction can be oriented in the XY-plane.

FIG. 4b shows material weakenings 111 in the fabric 100, with the material weakenings 111 having a shape that is different from that of the material weakenings 111 in FIG. 4a. The material weakenings 111 have an essentially quadrangular cross-section, e.g. a rectangular or quadratic cross-section. In the case of a quadratic cross-section, the mechanical property can be isotropic. In the case of a rectangular (non-quadratic) cross-section, the mechanical property can be anisotropic. This as described with a view to FIG. 4a.

FIG. 4c shows material weakenings 111 in the fabric 100. In this example, the material weakenings 111 have different orientations. The material weakenings 111 can have the same shape and be arranged rotated or turned relative to each other in the fabric 100.

In general, a first section 110 can have material weakenings 111 that are identical with respect to at least one property. The property can be a shape, a size, an extension into the fabric and/or a density of material weakenings 111. The density of material weakenings 111 can be stated as a number of material weakenings 111 per unit area, e.g. as material weakenings 111 per cm². At least 50% of the material weakenings 111 of the first section 110 can have at least one identical property. Likewise, material weakenings 111 in the first section 110 can have no identical property, in particular no identical property of the properties stated.

In general, the mechanical property can be isotropic or anisotropic. The mechanical property in a first direction (e.g. in X-direction) can be identical to the mechanical property in a second direction (e.g. in Y-direction). Alternatively, the mechanical property in a first direction (e.g. in X-direction) can be different from the mechanical property in a second direction (e.g. in Y-direction). Preferably, the first direction is nonparallel to the second direction, especially preferably the first direction is perpendicular to the second direction. The first and the second direction can be oriented in the X-Y-plane.

Different first sections 110 of the fabric 100 can have different material weakenings 111. For example, material weakenings 111 having at least one identical property can be arranged in a first section 110, and material weakenings 111 having at least one identical property can be arranged in a further first section 110. The at least one property of the material weakenings 111 in the first section 110 can be different from the (same) at least one property of the material weakenings 111 in the further first section 110. For example, the density of material weakenings 111 in a first section 110 can be higher than in a further first section 110 of the fabric 100.

Distances between material weakenings 111 in the first section 110 can be identical, in particular between all material weakenings 111 of the first section 110. Alternatively, distances between material weakenings 111 in the first section 110 can be different, preferably between at least 50% of the material weakenings 111, more preferably between all material weakenings 111. The distance can be located in the X-Y-plane. The distance can be located in X-direction and/or in Y-direction.

FIG. 5 shows a multi-layer fabric 500. The multi-layer fabric 500 can comprise any of the fabrics 100 disclosed herein.

In addition to the fabric 100, the multi-layer fabric 500 can comprise a coating 200. At least one side of the fabric 100 can be coated with the coating 200. Preferably, all sides of the fabric 100 are enclosed or covered by the coating 200.

On at least one side of the fabric 100, the coating 200 can have a greater or lower thickness than the fabric 100.

If the material weakening 111 is, e.g., a recess or a perforation, the coating 200 can also project into, or completely penetrate, the material weakening 111.

FIGS. 6a to 6d show steps of a method for manufacturing a fabric 100. Any of the fabrics 100 disclosed herein can be produced with the method.

In step S10 (FIG. 6a), a surface element 100a (also referred to as fabric precursor) can be provided. The surface element 100a has a first section 110a and a second section 120a. The surface element 100a has at least one mechanical property. In this step, the first section 110a and the second section 120a can have the same mechanical property, in particular the same mechanical property as the surface element 100a.

Preferably, the surface element 100a is made of one piece. The surface element 100a can be made of one (same) material.

In step S20 (FIG. 6b), one or multiple material weakenings 111 can be incorporated into or applied onto the first section 110a of the surface element 100a. The material weakening 111 or the material weakenings 111 can be any of the material weakenings 111 disclosed herein. Preferably, no material weakening 111 is incorporated into or applied onto the second section 120a of the surface element 100a. In particular, the mechanical property of the second section 120a of the surface element 100a is not changed.

The one or multiple material weakenings 111 can be incorporated into or applied onto the first section 110a by means of punching, perforating or squeezing, in particular by laser perforation. Any other method disclosed herein for incorporating or applying the one or multiple material weakenings 111 is possible.

In step S30 (FIG. 6c), a shape section 150 of the surface element 100a can be separated. The shape of the shape section 150 can correspond to the shape of the later fabric 100. The shape section 150 can have any shape. In particular, the shape section 150 can rectangular. The shape section 150 can be chosen thus that the first section 110a and the second section 120a of the surface element 100a are located within the shape section 150.

Step S40 (FIG. 6d) shows a fabric 100. The fabric 100 can have the shape of the shape section 150. The fabric 100 can have a first section 110. The first section 110 of the fabric 100 can be identical to the first section 110a of the surface element 100a. The fabric 100 can have a second section 120. The second section 120 of the fabric 100 can be identical to the second section 120a of the surface element 100a.

Each of the steps S10 to S40 can be an optional step.

The fabric 100 can be provided with a coating 200. This enables production of any of the multi-layer fabrics 500 disclosed herein.

FIG. 7 shows a side view of a transition element 1000. The transition element 1000 can be a bellows, in particular a folded or a corrugated bellows. The transition element 1000 can comprise a fabric 100, in particular a multi-layer fabric 500.

The transition element 1000 can comprise a transition element wall 1010. The transition element wall 1010 can comprise or consist of the fabric 100 or the multi-layer fabric 500. For a transition element wall 1010, the fabric 100 or the multi-layer fabric 500 can be shaped in such a way that the wall encloses a tunnel-shaped or channel-shaped space.

The cross-section of the transition element wall 1010 can be rectangular or box-shaped. The transition element wall 1010 can have multiple corners, e.g. for corners. Side areas, a roof area, and a floor area can be formed between the corners. The fabric 100 can be arranged in the transition element 1000 in such a way that at least a first section 110 is arranged in a corner of the transition element wall 1010. In particular, the fabric 100 is arranged in the transition element 1000 in such a way that, in each case, a first section 110 is arranged in each corner of the transition element wall 1010.

The fabric 100 can be arranged in the transition element 1000 in such a way that at least a second section 120 is arranged in a side, floor or roof area of the transition element wall 1010. In particular, the fabric 100 is arranged in the transition element 1000 in such a way that, in each case, a second section 120 is arranged in each side, floor and/or roof area of the transition element wall 1010.

Due to the arrangement of a first section 110, having at least one material weakening 111, in a corner of the transition element wall 1010, the fabric can be well draped there. In the side, floor and roof areas of the transition element wall 1010, the second section 120 can absorb greater forces.

The transition element 1000 can comprise multiple frames 1030 arranged at a distance to one another, e.g. bellow tensioning frames. The frames 1030 can completely encompass the transition element 1000. Transition element walls 1010 can be clamped between the frames 1030.

FIG. 8 shows a vehicle 2000. The vehicle 2000 can comprise a first vehicle part 1100 and a second vehicle part 1200. The transition element 1000 can be arranged between the first and the second vehicle part 1100, 1200. The transition element 1000 can protect a transition area of the two movably interconnected vehicle parts 1100, 1200. The vehicle can be a rail vehicle or a bus, in particular an articulated bus.

The first and the second vehicle part 1100, 1200 can be connected twistable relative to each other around a vertical rotary axis and/or relocatable relative to each other in the direction of travel and/or relocatable transverse to the direction of travel and/or rotatable around a longitudinal axis of the vehicle.

The transition element 1000 can be used to protect a transition area of a boarding bridge or boarding stairs. Likewise, the transition element 1000 can be used to protect a transition area between two parts of a building, e.g. between a bridge and a building section.

FIG. 9a shows a concrete example of how a fabric 100 for a corner of a transition element 1000 in the form of a corrugated bellows can look like. It is a strip-shaped fabric 100 with two edge areas and a center area indicated by a broken line. Multiple first sections with material weakenings 111 are provided in the fabric 100. In the example shown, the center area is designed without material weakenings 111, i.e., it is the second section 120. The first sections 110 differ in particular as regards the size of the material weakenings 111. The size of the material weakenings 111 increases in the direction of the edge areas of the fabric 100.

FIG. 9b shows a schematic diagram of the fabric 100 according to FIG. 9a after the coating step in which the fabric 100 is coated with the coating 200 on both sides and after a shaping step in which the fabric 100 is shaped into the desired corner for the transition element 1000. Due to the larger material weakenings 111 in the edge areas, the fabric 100 can be shaped more intensely in the edge areas than, e.g., in the center area without folds forming or with folds forming only to an insignificant extent.

FIG. 10 shows a fabric 100 with further examples of the designing of the material weakenings 111. Specifically, the material weakenings 111 can have undercuts, various combined geometries, various combined sizes etc. The geometries, sizes and combinations of geometries and sizes shown for the material weakenings 111 are only examples.

### LIST OF THE REFERENCE SIGNS

100 Fabric
100a Surface element
110 Section
110a Section
111 Material weakening
120 Section
120a Section
150 Shape section
200 Coating
500 Multi-layer fabric
1000 Transition element
1010 Transition element wall
1020 Transition element wall section
1030 Frame
1100 Vehicle part
1200 Vehicle part
2000 Vehicle

1. A fabric for a transition element for protection of a transition area between two interconnected components or vehicle parts that can move relative to each other, comprising:
a fabric having at least one first section and at least one second section;
wherein the first section and the second section differ with respect to at least one mechanical property; and
wherein the first section has at least one material weakening to change the at least one mechanical property in the first section.

2. The fabric according to claim 1, wherein the at least one mechanical property comprises:
a bending stiffness; and/or
an elasticity; and/or
a modulus of elasticity; and/or
a maximum tensile force; and/or
a maximum force at elongation; and/or
a tensile force and/or
an elongation.

3. The fabric according to claim 1, wherein:
the bending stiffness is determined in accordance with VDA 230-209 Part C;
the elasticity is determined in accordance with DIN EN ISO 20932-1:2020-05; and
the elongation is determined in accordance with DIN EN ISO 13934-1:2013-08.

4. The fabric according to claim 2, wherein:
the bending stiffness in the first section is lower than in the second section; and/or
the elasticity in the first section is higher than in the second section; and/or
the modulus of elasticity in the first section is lower than in the second section; and/or
the maximum tensile force in the first section is lower than in the second section; and/or
the maximum force at elongation in the first section is greater than in the second section; and/or
the tensile force in the first section is lower than in the second section; and/or
the elongation in the first section is greater than in the second section.

5. The fabric according to claim 1, wherein the material weakening is a recess, a perforation, an indentation, a contraction and/or a reduction of thickness.

6. The fabric according to claim 5, wherein the material weakening is a perforation or a laser perforation.

7. The fabric according to claim 1, wherein:
the material weakening has a circular, oval, triangular, quadrangular, rectangular, quadratic, or n-gonal cross-section; and/or
the material weakening has a cross-sectional area of at least 0.5 mm², or at least 1 mm², or at least 3 mm², or at least 6 mm².

8. The fabric according to claim 1, wherein:
the first section has a multitude of material weakenings; and/or
the second section has between 0.01 material weakenings per cm² and 100 material weakenings per cm², or between 0.05 material weakenings per cm² and 50 material weakenings per cm², or between 0.1 material weakenings per cm² and 10 material weakenings per cm².

9. The fabric according to claim 8, wherein multitude of material weakenings in the the first section comprises at least 10 material weakenings, or at least 50 material weakenings, or at least 100 material weakenings.

10. The fabric according to claim 1, wherein:
the material weakenings are arranged in a regular grid pattern in the first section; or
the material weakenings are arranged unevenly in the first section.

11. The fabric according to claim 1, wherein:
an area of the first section is at least 5%, or at least 10%, of a total area of the fabric; and/or
an area of the second section is at least 20%, or at least 30%, of the total area of the fabric, and/or
an area of the first section is at least 10 cm², or at least 20 cm², or at least 30 cm².

12. The fabric according to claim 1, wherein:
the fabric comprises a polyester, a polyamide, an aramid, polypropylene, cotton and/or viscose; and/or
the fabric is a woven fabric, a crocheted fabric, a knitted fabric, a non-woven fabric, or a scrim.

13. The fabric according to claim 1, wherein the fabric is a textile fabric.

14. A multi-layer fabric for a transition element for protection of a transition area between two interconnected components or vehicle parts that can move relative to each other, comprising:
a multi-layer fabric comprising the fabric according to claim 1; and
at least one side of the fabric has a coating.

15. The multi-layer fabric according to claim 14, wherein:
all sides of the fabric have the coating, and/or
the coating comprises a plastic; and/or
the coating has a greater thickness or a lower thickness than the fabric.

16. The multi-layer fabric according to claim 14, wherein the coating comprises a plastic, the plastic being an elastomer, a silicone, a chlorosulfonated polyethylene, a TPU, EPDM and/or PVC.

17. A method for the production of a fabric for a transition element for protection of a transition area between two interconnected components or vehicle parts that can move relative to each other, comprising:
providing a surface element having at least one mechanical property and at least one first section and at least one second section;
applying or incorporating at least one material weakening onto or into the surface element in the first section, so that the at least one mechanical property in the first section is changed; and
thereby obtaining of a fabric having at least a first section and at least a second section, the first section and the second section (120) being different with respect to the at least one mechanical property.

18. The method according to claim 17, wherein the step of applying or incorporating at least one material weakening onto or into the surface element in the first section comprises applying or incorporating the at least one material weakening by laser perforation.

19. The method according to claim 17, wherein:
the method further comprises separation of a shape section of the surface element, the shape section comprising the first section and the second section, the shape section having a shape, and the fabric having the shape of the shape section; and/or
the method further comprises application of a coating onto at least one side of the surface element or the fabric, the coating at least partly covering the first section; and/or
the second section of the fabric having the at least one mechanical property of the surface element; and/or
the at least one mechanical property of the surface element not being changed.

20. A transition element for protection of a transition area between two interconnected components or vehicle parts that can move relative to each other, comprising the fabric according to claim 1.

21. A vehicle, boarding bridge, boarding stairs or building connection with two interconnected components or vehicle parts that can move relative to each other and a transition element according to claim 20.
